(19) United States
(12) Patent Application Publication
(10) Pub. No.: US 2007/0124878 A1
(43) Pub. Date: Jun. 7, 2007

(54) Dust removing machine for carbody painting shops

(75) Inventors: Jose Rodrigues, Saint-Guillaume (FR); Andre Surpi, Seyssinet-Pariset (FR); Pierre Chamond, Provesieux (FR)

Correspondence Address: CANTOR COLBURN, LLP, 55 GRIFFIN ROAD SOUTH, BLOOMFIELD, CT, 06002, US

(73) Assignee: EISENBANN FRANCE SARL, Chatou (FR)

(21) Appl. No.: 10/558,600

(22) PCT Filed: May 19, 2004
(86) PCT No.: PCT/FR04/01250

§ 371 Date: Jan. 12, 2007

(30) Foreign Application Priority Data
May 30, 2003 (FR) 03/06591

(51) Int. Cl. B60S 3/06

(52) U.S. Cl. 15/97.3; 15/53.2

(57) ABSTRACT

A machine (4) is provided for removing dust from carbodies, before the paint coatings are applied to said bodies. Said machine is built on the principle of feather rollers rotary mounted about their central axis and rotationally driven, such as to engage the carbodies moved forward on a conveyer. At least two feather rollers (26, 27) extend one after the other, and are synchronously driven, with the angle between the respective axis (28, 29) of the consecutive rollers (26, 27) being adjustable by changing the tilting of at least one of their axis (28, 29). The machine can therefore accommodate varying carbody profiles. Such a design is applicable to dust removing roof and side machines.

The present invention relates to a dust-removal machine intended to equip paint shops, particularly for painting motor vehicle bodywork, such as the bodies of touring cars, vans or buses, this machine being designed to remove dust from the bodies before the various necessary coats of paint are applied.

Current dust-removal devices for removing dust prior to painting bodies usually employ ostrich feathers, installed on a rotary hub at right angles to the axis of this hub and thus forming a feather roller able to be rotationally driven about its central axis. Such a feather roller, comparable with a large rotary brush, has for example a diameter of about 0.6 meters, and a length of the order of 1.2 meters. By way of example of such a feather roller, reference is here made to U.S. Pat. No. 4,760,620.

As the bodywork driven forward on a conveyer passes, the feather rollers are rotated and brought up close enough to the bodies for the feathers to rub against these bodies and pick up the dust, and carry it into the cowling of the machine where a deionization bar, placed parallel to the axis of the roller and along its entire height, and supplied with AC current, cancels the electrical charges acquired by the feathers via a triboelectric phenomenon as they rub against a bodywork, which charges attract the particles of dust picked up from the bodywork toward themselves and hold on to them.

Next, the roller feathers, driven in rotation with this roller, file past a suction nozzle in the form of a slot parallel to the axis of the roller, which nozzle sucks off the dust and usually carries it away to an aspirated-air filtration device.

As the roller continues to rotate, the feathers, freed of the dust previously collected, return toward the bodywork in a state of cleanliness, and the abovedescribed cycle recommences.

Dust-removal machines operating on the principle that has just been recalled, are grouped together to constitute dust-removal installations, as indicated, for example, in German patent DE 2 619 614 or in German patent DE 4 339 613, or alternatively U.S. Pat. No. 5,524,329. Such installations consist of two or four side machines, with feather rollers of more or less vertical axis, which remove dust from the bodywork parts that are more or less vertical and parallel to the longitudinal direction of travel of the conveyer, and of a machine known as an “overhead” machine, with a roller of more or less horizontal axis, which removes dust from the bodywork parts that are more or less horizontal, or parts which are oblique or more or less vertical and perpendicular to the longitudinal direction of travel of the conveyer.

Thus, in the case of a touring car, the parts from which dust is removed by the overhead machine are generally the front, the hood, the roof, the trunk or the tailgate, and the rear of the bodywork. As disclosed for example in the aforementioned German patent DE 2 619 614, the feather roller of the overhead machine consists of a straight one-piece hub mounted to rotate about its horizontally arranged geometric axis. The length of the feathers installed in the hub may vary along the length of this hub, so as to obtain, in the case of the feather roller, a non-cylindrical exterior shape corresponding to the average profile of the bodywork parts from which dust is to be removed.

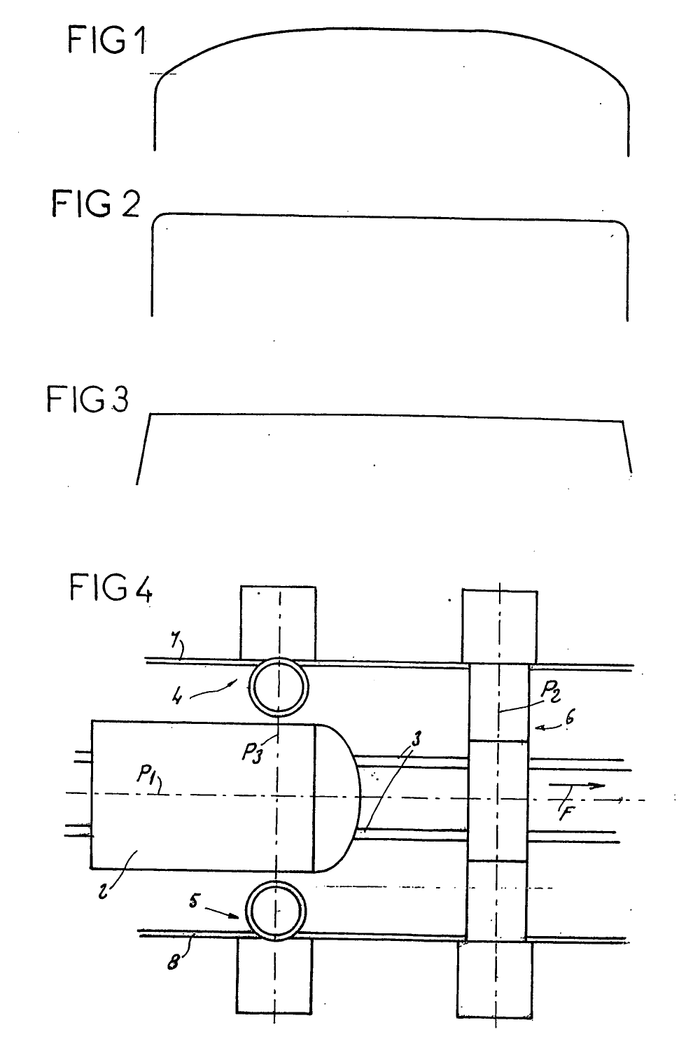

The parts of a bodywork from which dust is removed by such an overhead machine may in effect be, in transverse profile, either generally convex with more conspicuously rounded ends, or more or less flat with more or less rounded ends etc.; FIGS. 1, 2 and 3 of the attached drawing show schematically, and by way of examples, profiles which may thus currently be encountered.

On the whole, the shapes of the roof on the one hand and of the hoods of the same car body on the other hand, may already be fairly dissimilar in the cross sections of this bodywork and, in any event, the differences observed from one vehicle model to another, for the same motor manufacturer, also prove to be very great.

Now, at the present time, as already mentioned hereinabove, the horizontal roller of the overhead machine is merely equipped with feathers of varying length, generally longer toward the ends of the roller than at its middle, so as to approximate to an average profile supposed to suit various models of bodywork and various bodywork parts, such as hood, roof, and tailgate from which dust is to be removed. Reference is made here to the explanations of the aforementioned U.S. Pat. No. 4,760,620.

However, given the current body shapes, which are sometimes very unusual, and the increasing trend to use the same production line to process vehicle models that differ widely from one another, both in terms of their size and in terms of their shape, it will be readily understood that the known solution recalled hereinabove represents a compromise that is difficult to accept because it is somewhat incompatible with correct dust removal from all the bodyworks that need to be painted.

A similar problem arises in the case of dust-removal machines placed along the sides of the production line and intended to remove dust from the flanks of the bodywork. Not only do the widths and heights of the bodyworks vary, but also, depending on the curvature of the bodywork, the profile of the flanks of the bodyworks is currently becoming highly variable. In the case of the aforementioned German patent DE 619 614, the feather rollers of the side machines have a vertical axis and are equipped with feathers of varying length, according to the same principle as the overhead machine mentioned earlier. In the case of the other aforementioned German patent DE 4 339 613, the feather rollers of the side machines have a cylindrical shape but their axis can be inclined in a plane perpendicular to the longitudinal direction of travel of the conveyer. In all cases, a single one-piece roller removes the dust from the side of the bodywork over its entire height. These solutions too prove unsatisfactory.

It should also be considered here that the feather rollers are delicate and expensive components and the incorrect or approximate positioning of these rollers relative to the bodywork carries a risk of damaging the feathers through excessive bending and of entailing early replacement of said rollers.

The present invention aims to remedy the aforementioned disadvantages by providing a novel design of dust-removal machine that can be applied equally to an overhead machine and to a side machine, which allows easy adaptation to suit bodyworks of very diverse size and shape, and which in particular allows the feather rollers to best follow the various profiles of bodywork, for effective dust removal, while at the same time best preserving these feather rollers.

To this end, the subject of the invention is a dust-removal machine for vehicle body paint shops, this machine being designed on the principle of at least one feather roller mounted to rotate about its central axis and driven in rotation in such a way as to come into contact with bodies driven forward on a conveyer, the machine essentially being characterized in that it comprises at least two feather rollers arranged more or less in a continuation of one another, and driven in synchronous rotation, the respective axes of these rollers lying more or less in the same vertical plane transverse to the longitudinal direction of travel of the conveyer and the feather rollers being mounted in such a way that the angle formed by the respective axes of the consecutive rollers can be adjusted by changing the inclination of the axis of at least one roller.

In one particular embodiment, the feather rollers are mounted in such a way that changing the inclination of the axis of at least one feather roller is accompanied by a translational movement of this roller along the same axis, so as to keep the feather density at the point of tangency between two consecutive rollers more or less constant irrespective of the angle formed by the respective axes of these rollers.

Thus, the idea underlying the invention, which applies equally to an overhead machine and to a side machine for removing dust, consists in replacing the conventional single feather roller with at least two rollers positioned one after the other, with a possibility of varying the relative angle between the axes of these rollers, rotationally driven in synchronism. In particular, two or three rollers, the respective axes of which form a broken line, allow relatively precise adaptation to suit each bodywork profile, top or side, it being possible for the relative angle between the feather rollers to be modified not only between two different bodyworks arriving at the dust-removal machine in succession, but also as a single bodywork files past in order to take account of its profile that varies between the front and the rear. Pivoting and any translational movements of the various feather rollers are advantageously brought about by servomotors, themselves driven, for example by a robot control bay, a programmable controller or a microcomputer.

In the case of an overhead machine, the latter advantageously comprises three feather rollers, namely a central roller with longitudinal axis and two side rollers the axes of which can be inclined, particularly symmetrically, with respect to the horizontal, the respective axes of the three rollers being kept in the same vertical plane irrespective of the inclination of the side rollers. In addition, the two side rollers can perform a translational movement along their respective axes as they become inclined, so as to keep the feather density at the points of tangency of these side rollers with the central roller more or less constant. The set of three rollers of the overhead machine is supported by a horizontal suction casing able to be driven in a vertical up and down movement so as to be able to alter the height of this set of rollers, so as to follow the longitudinal profile of a bodywork.

In the case of a side machine, the latter comprises two superposed feather rollers the respective axes of which can be inclined independently of one another with respect to the vertical, the respective axes of the two rollers being kept in the same vertical plane irrespective of their inclination. In this case too, at least one of the two rollers can perform a translational movement along its axis, so as to keep the feather density at the point of tangency of the two rollers more or less constant. The set of two superposed rollers of the side machine is supported by a vertical casing which can be moved transversely to the longitudinal direction of travel of the conveyer in order to be brought closer to or further away from the mid-plane of this conveyer, so as to adapt to the width of each of the types of bodywork from which dust is to be removed on the same production line.

The invention will be better understood with the aid of the description which follows, with reference to the attached schematic drawing which, by way of examples, depicts some embodiments of this dust-removal machine:

FIGS. 1, 2 and 3 (which have already been mentioned) show various possible transverse profiles of the upper part of a motor vehicle bodywork;

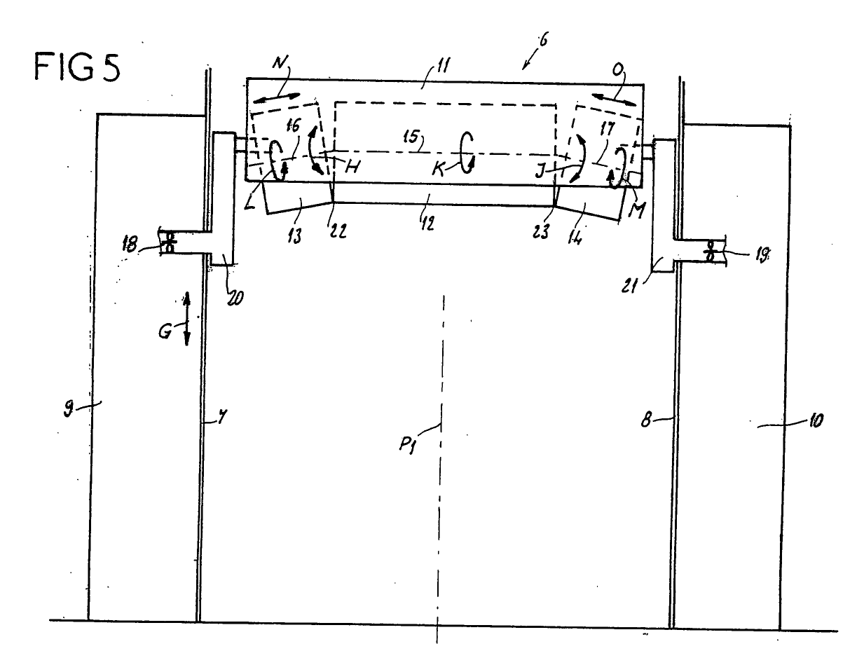

FIG. 4 is a highly schematic plan view of a dust-removal installation composed of an overhead machine and of two side machines;

FIG. 5 is a face-on view of an overhead machine according to the present invention;

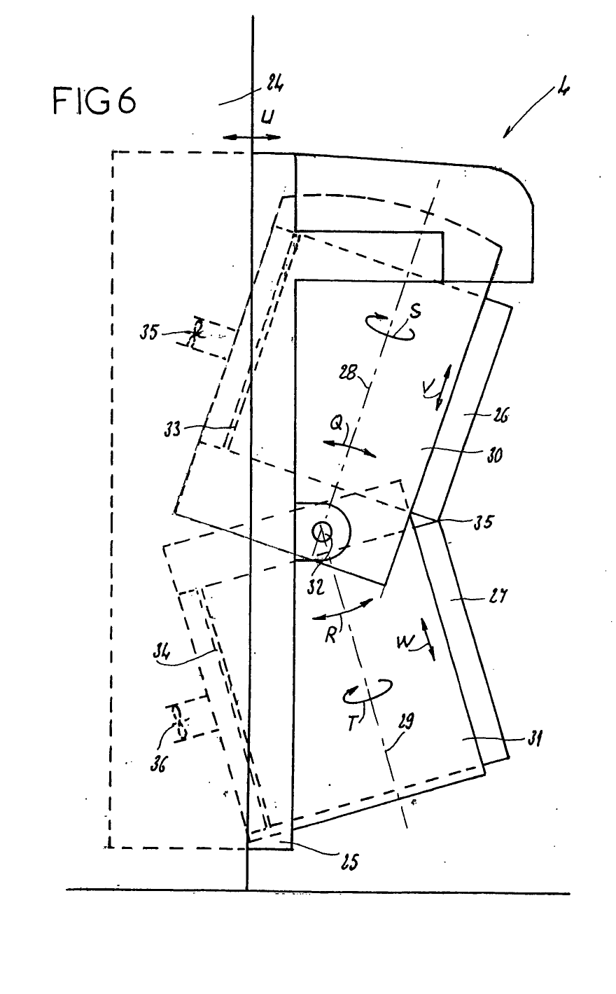

FIG. 6 is a face-on view of a side machine according to the present invention.

FIG. 4 depicts an installation for removing dust from motor vehicle bodyworks, forming a station placed on a production line and in which the bodyworks 2 from which dust is to be removed are driven forward on a conveyer 3 which itself moves longitudinally in a direction of forward travel indicated by an arrow F. The dust-removal installation is produced symmetrically with respect to the longitudinal mid-plane P1 of the conveyer 3. This dust-removal installation is made up of two side machines 4 and 5 and of an overhead machine 6. The two side machines 4 and 5 are positioned facing one another, one on each of the two sides of the conveyer 3, upstream of the overhead machine 6 (with reference to the direction of travel F of the conveyer 3). As this is a bodywork paint shop, the conveyer 3 and the bodyworks 2 are located inside a paint booth, the side walls of which are indicated schematically as 7 and 8. The dust-removal machines 4, 5 and 6 have frameworks placed outside the walls 7, 8 of the paint booth and active parts, in the form of feather rollers, placed inside this booth, so that they can come into contact with the bodyworks 2 from which dust is to be removed. Each dust-removal machine 4, 5 or 6 comprises two or three feather rollers arranged in a special way as described in more detail hereinafter with reference to the next FIGS. 5 and 6.

The overhead machine 6 will be described first of all, with reference to FIG. 5. This overhead machine 6 comprises two side posts 9 and 10 placed facing each other outside the side walls 7 and 8 of the paint booth, which posts contain a certain amount of drive and guide components, not detailed or depicted here in order to simplify the drawing and make it clearer. Between the two side posts 9 and 10 there runs transversely a horizontal suction casing 11 placed inside the paint booth and surmounting the conveyer 3. The mechanism of the posts 9 and 10 is designed to drive the casing 11 in an up and d down vertical movement in the direction of the arrow G in order to position this casing 11 at any desired height.

The casing 11, open at its bottom, supports and partially encloses a set of three feather rollers 12, 13 and 14, the respective axes of which are indicated as 15, 16 and 17. Here may be seen a central roller 12, of relatively great length and two side rollers 13 and 14, of shorter length, arranged symmetrically on each side of the central roller 12.

The axis 15 of the central roller 12 is kept horizontal. The respective axes 16 and 17 of the two side rollers 13 and 14 have a horizontal basic position but can be inclined with respect to this basic position as indicated by the arrows H and J. In particular, the outer ends of the two side rollers 13 and 14 may thus be lowered, relative to their inner ends. The respective axes 15, 16 and 17 of the three rollers 12, 13 and 14 are kept in the same vertical plane P2 transverse to the direction of travel F of the conveyer 3 irrespective of the inclination of the side rollers 13 and 14.

The central roller 12 is designed to be rotationally driven in the direction of the arrow K about its axis 15. The two side rollers 13 and 14 are designed to be rotationally driven in the direction of the arrows L and M about their own axes 16 and 17. The three rollers 12, 13 and 14 are thus driven in rotation in the same direction synchronously by motorized means, not detailed.

The horizontal casing 11 also comprises deionization bars and suction slots, these parts being generally known in dust-removal machines of the kind concerned. The suction slots are connected to fans 18 and 19 housed in the side posts 9 and 10 by devices 20 and 21 of the hollow crank and link-rod type which provide the connection between the side posts 9 and 10 and the horizontal casing 11 and which control the up and down movement of this casing 11 in the direction of the arrow G.

The overall up and down movement of the casing 11 allows the set of the three rollers 12, 13 and 14 during operation to be made to follow the longitudinal profile of each bodywork 2 as it progresses along the conveyer 3. This up and down movement allows the rollers 12, 13 and 14 to follow the more or less horizontal parts (roof, hood) of the bodyworks 2 with as much ease as they do their inclined parts (tailgate) and even their more or less vertical parts (front face and rear face).

In addition, in order to adapt to suit the various transverse profiles of a moving bodywork 2, and also the various types of bodywork usually produced, such as the profiles illustrated in FIGS. 1, 2 and 3, the two side rollers 13 and 14 can adopt a varying inclination with respect to the horizontal, as shown in FIG. 5.

In order to keep the feather density of the rollers constant at the two points of tangency 22 and 23 between the central roller 12 and the two side rollers 13 and 14, provision is advantageously made for these two side rollers 13 and 14 to describe an additional translational movement along their axes 16 and 17 as symbolized by the arrows N and 0, this translational movement moving the side rollers 13 and 14 away from the central roller 12 as they gradually become inclined.

Depending on the geometry of each bodywork 2, the overhead machine 6 needs to appropriately combine and coordinate the heightwise positioning of the horizontal casing 11 and the inclination of the two side rollers 13 and 14 and, if appropriate, the translational movements of these side rollers 13 and 14. All these positionings and movements are coordinated via a robot control bay, a programmable controller or a microcomputer driving various servomotors or rams or other actuators so as to adapt the position of each feather roller 12, 13 or 14 to suit each type of bodywork 2 that may arrive on the conveyer 3, and to suit each point of a bodywork which, at a given moment, faces the feather rollers 12, 13 and 14.

One 4 of the two side machines 4 and 5 will now be described with reference to FIG. 6, in the knowledge that the other, 5, of these two machines is strictly symmetric with the first.

The side machine 4 comprises an essentially metal framework 24 rising up vertically on one side of the production line and housing the various drive and guide components needed, which are not depicted here in order to simplify the drawing and make it clearer. The frame 24 comprises a vertical casing 25 made of plastic or of steel, running more or less in a vertical direction and open on its side facing toward the longitudinal mid-plane P1 of the conveyer 3.

Mounted on the casing 25 are two superposed feather rollers, an upper roller 26 and a lower roller 27, respectively, the respective axes of which are indicated as 28 and 29. Each roller 26 or 27 is housed in a support jacket 30 or 31 respectively, the two jackets 30 and 31 being mounted to pivot about one and the same horizontal axis 32, situated at an intermediate height, the axis 32 being directed parallel to the longitudinal mid-plane P1 of the conveyer 3.

Thus, the two rollers 26 and 27 have a vertical basic position but can be inclined independently of one another at the same time as their respective jackets 30 and 31 by pivoting about the horizontal axis 32 as indicated by the arrows Q and R. The respective axes 28 and 29 of the two rollers 26 and 27 are thus kept in the same vertical plane P3 transverse to the direction of travel F of the conveyer 3 irrespective of their inclination.

The two superposed rollers 26 and 27 are designed to be rotationally driven in the direction of the arrows S and T about their own axes 28 and 29, synchronously, by motorized means which have not been detailed.

Each support jacket 30 or 31 of a feather roller 26 or 27 comprises a suction slot 33 or 34 respectively connected by a suction duct to a respective fan 35 or 36.

The vertical casing 25 of the side machine 4 is mounted so that it can be moved horizontally and transversely to the direction of travel F of the conveyer 3 in the direction of the arrow U so as to adapt the position of the set of two rollers 26 and 27 of this machine 4 to suit the width of each of the types of bodywork 2 produced, by moving these two rollers 26 and 27 closer to or further away from the longitudinal mid-plane P1 of the conveyer 3.

In addition, in order to adapt the side machine 4 to suit the profile of the flanks of the bodywork 2, each of the two feather rollers 26 and 27 can be inclined more or less steeply with respect to the vertical, independently of the other roller, by pivoting about the axis 32. In particular, as shown by FIG. 6, the upper roller 26 can be inclined in such a way that its upper end is brought closer to the longitudinal mid-plane P1 of the conveyer 3 than its lower end. The lower roller 27 can in particular be inclined in the opposite direction, that is to say that its lower end is brought closer to the longitudinal mid-plane P1 of the conveyer than its upper end.

In order to keep the feather density of the rollers at the point of tangency 35 between the upper roller 26 and the lower roller 27 constant, provision is advantageously made for these two rollers 26 and 27, or for at least one of these two rollers, to describe an additional translational movement along their axes 28 and 29 as symbolized by the arrows V and W; this translational movement moves the roller 26 or 27 away from the axis of pivoting 32 as said roller gradually becomes inclined with respect to the vertical.

The positionings and movements of the casing 25 and of the two rollers 26 and 27 are coordinated via a robot control bay, a programmable controller or a microcomputer driving various servomotors or rams or other actuators so as to adapt the position of the feather rollers 26 and 27 to suit the lateral profile of each type of bodywork 2 which may arrive on the conveyer 3, and to suit each point of the bodywork which, at a given moment, faces the feather rollers 26 and 27.

It will be understood that, through the combination of the action of the two side machines 4 and 5 and of the overhead machine 6 which were described hereinabove and given the tailored positioning of the respective feather rollers 12, 13, 14, 26, 27 of these machines, perfect removal of dust from the bodyworks 2 driven forward on the conveyer 3 is achieved, particularly from those parts of the bodyworks handled by these machines 4, 5 and 6 respectively. In addition, adapting the feather rollers 12, 13, 14, 26, 27 to suit the profile of the bodyworks 2 prevents the feathers, which are delicate items, from becoming bent and broken by pressing against parts of the bodywork.

The following would not constitute departures from the scope of the invention as defined in the attached claims:

if machines were produced that comprised a different number of feather rollers, provided this number was at least equal to two;

if any arrangement was used for these feather rollers and their mounting, for example if the rollers of cylindrical appearance (as depicted in the drawing), were replaced by rollers with feathers of differentiated lengths differing according to annular regions, in order to supplement and further refine the advantages of the machine according to the invention by allowing the ends of the feathers to follow the various bodywork profiles even more closely;

if any means, motorized or otherwise, were used for adjusting the positions and inclinations of the rollers, it being possible in some instances for some or all of the translational or angling movements to be done manually or semi-manually;

and finally, if the invention were to be applied only to an overhead machine or to side machines rather than to an entire dust-removal installation and/or if the functions described were to be implemented only partially according to the particular applications encountered.

1. A dust-removal machine for vehicle body paint shops, this machine being designed on the principle of at least one feather roller mounted to rotate about its central axis and driven in rotation in such a way as to come into contact with bodies driven forward on a conveyer, the machine comprising:
at least two feather rollers arranged more or less in a continuation of one another, and driven in synchronous rotation, respective axes of these rollers lying more or less in a same vertical plane transverse to a longitudinal direction of travel of a conveyer and the feather rollers being mounted in such a way that the angle formed by respective axes of the consecutive rollers can be adjusted by changing an inclination of the axis of at least one roller.

2. The dust-removal machine as claimed in claim 1, wherein the feather rollers are mounted in such a way that changing the inclination of the axis of at least one feather roller is accompanied by a translational movement of this roller along the same axis.

3. The dust-removal machine as claimed in claim 2, wherein the pivotings and any translational movements of the various feather rollers are brought about by servomotors driven, by a robot control bay, a programmable controller or a microcomputer.

4. The dust-removal machine as claimed in claim 1, wherein it is an overhead machine and comprises three feather rollers, including a central roller with horizontal axis and two side rollers the axes of which can be inclined, particularly symmetrically, with respect to the horizontal, the respective axes of the three rollers being kept in the same vertical plane Irrespective of the inclination of the side rollers.

5. The dust-removal machine as claimed in claims wherein the two side rollers perform a translational movement along their respective axes as they become inclined, so as to keep a feather density at points of tangency of the side rollers with the central roller more or less constant.

6. The dust-removal machine as claimed in claim 4, characterized in that the set of three rollers of this overhead machine is supported by a horizontal suction casing able to be driven in a vertical up and down movements so as to be able to alter a height of this set of rollers.

7. The dust-removal machine as claimed in claim 1, wherein it is a side machine and comprises two superposed feather rollers the respective axes of which can be inclined independently of one another with respect to a vertical, the respective axes of the two rollers being kept in the same vertical plane irrespective of their inclination.

8. The dust-removal machine as claimed in claim 7 wherein at least one of the two rollers performs a translational movement along its axis as it is inclined, so as to keep a feather density at a point of tangency of the two rollers more or less constant.

9. The dust-removal machine as claimed in claim 7, wherein the set of two superposed rollers of this side machine is supported by a vertical casing which can be moved transversely to the longitudinal direction of travel of the conveyer in order to be brought closer to or further away from a mid-plane of this conveyer.
